(19) United States
(12) Patent Application Publication
(10) Pub. No.: US 2013/0129163 A1
(43) Pub. Date: May 23, 2013

(54) FINGERPRINT SENSOR AND METHOD OF OPERATING THE SAME

(71) Applicants: Il Kwon CHUNG, Seongnam (KR); Seung Seoup LEE, Suwon (KR); Jae Hyouck CHOI, Seongnam (KR); Jun Kyung NA, Anyang (KR)

(72) Inventors: Il Kwon CHUNG, Seongnam (KR); Seung Seoup LEE, Suwon (KR); Jae Hyouck CHOI, Seongnam (KR); Jun Kyung NA, Anyang (KR)

(73) Assignee: SAMSUNG ELECTRO-MECHANICS CO., LTD., Suwon (KR)

(21) Appl. No.: 13/358,906

(22) Filed: Jan. 26, 2012

(30) Foreign Application Priority Data
Nov. 21, 2011 (KR) 10-2011-0121829

(51) Int. Cl. G06K 9/00

(52) U.S. Cl. 382/124

(57) ABSTRACT

There are a fingerprint sensor and a method of operating the same. The fingerprint sensor includes: a fingerprint sensing unit sensing a fingerprint coming into contact with one surface of a substrate; a light source provided at a first end of the substrate; and a light detection unit provided at a second end of the substrate and detecting light emitted from the light source, wherein the first and second ends correspond to both ends of the one surface of the substrate with which the fingerprint comes into contact, respectively, and bio-information of an object coming into contact with the one surface of the substrate is determined by using light detected by the light detection unit.

### CROSS-REFERENCE TO RELATED APPLICATIONS

This application claims the priority of Korean Patent Application No. 10-2011-0121829 filed on Nov. 21, 2011, in the Korean Intellectual Property Office, the disclosure of which is incorporated herein by reference.

### BACKGROUND OF THE INVENTION

1. Field of the Invention

The present invention relates to a fingerprint sensor capable of discriminating a forged fingerprint by determining whether or not an object in contact therewith is a living body, upon recognizing a fingerprint thereof, to thus provide an excellent security function, and a method of operating the same.

2. Description of the Related Art

A fingerprint sensor, a sensor for sensing a human's fingerprint, is a device widely used to turn the power of an electronic device on or off or determine whether to release a sleep mode of an electronic device, as well as being applied to devices such as a door lock, and the like. In particular, recently, unlike a fingerprint sensor generally applied to a door lock, a swipe type fingerprint sensor implemented to have a small volume has been developed and has tended to be increasingly applied to mobile devices.

In particular, recently, as smart phones, tablet PCs, and the like have become prevalent, various types of confidential personal information, in particular, banking information, or the like, are commonly stored on mobile devices. Thus, when a smart phone, a table PC, or the like, containing a user's personal information is lost or has gone missing, the hacking of banking information, or the like, is highly likely to occur, lead to secondary damages. In order to prevent this, a security function, such as pattern recognition, a password, or the like, is applied to mobile devices, which, however, is still not free from the danger of hacking.

In the case of a fingerprint sensor, a fingerprint pattern particular to a certain individual is stored therein, and when a fingerprint which is not identical thereto is input, access to a mobile device is blocked, thereby providing superior security performance to that of the method such as a password or pattern recognition. However, even in the case of the fingerprint sensor, if the fingerprint sensor is accessed by a forged fingerprint fabricated with silicon, or the like, the forged fingerprint and a real bio-fingerprint may not be discriminated leading to the security system being incapacitated.

### SUMMARY OF THE INVENTION

An aspect of the present invention provides a fingerprint sensor in which a light source and a light detection unit are provided, in addition to a fingerprint sensing unit for sensing a fingerprint in order to determine whether an object in contact therewith is a living body, based on a quantity of light detected by the light detection unit. In particular, an aspect of the present invention provides a fingerprint sensor capable of discriminating a bio-fingerprint and a forged fingerprint while significantly reducing additionally required space in a device by disposing the light source and the light detection unit at both ends of one surface of a substrate accommodating a contact object.

According to an aspect of the present invention, there is provided a fingerprint sensor including: a fingerprint sensing unit sensing a fingerprint which comes into contact with one surface of a substrate; a light source provided at a first end of the substrate; and a light detection unit provided at a second end of the substrate and detecting light emitted from the light source, wherein the first and second ends correspond to both ends of the one surface of the substrate with which the fingerprint comes into contact, respectively, and bio-information of an object in contact with the one surface of the substrate is determined by using light detected by the light detection unit.

The fingerprint sensing unit may include: a plurality of electrodes having electrical conductivity; and a fingerprint calculation unit detecting the fingerprint by using a change in capacitance generated in the plurality of electrodes by the object in contact with the one surface of the substrate.

The fingerprint sensor may further include: a bio-information calculation unit determining bio-information of the object in contact with the one surface of the substrate by using light detected by the light detection unit.

The bio-information calculation unit may determine the bio-information by using a difference between a refractive index of the interior of the substrate and that of the object in contact with the one surface of the substrate.

The bio-information calculation unit may determine the bio-information of the object in contact with the one surface of the substrate with reference to a data table storing information regarding a quantity of light detected by the light detection unit according to a component of the object in contact with the one surface of the substrate.

The light source may include at least one light emitting diode (LED).

According to another aspect of the present invention, there is provided a method of operating a fingerprint sensor, including: detecting a change in capacitance generated from a plurality of electrodes by an object coming into contact with a substrate; detecting light emitted from a light source; and determining a fingerprint of the object in contact with the substrate, based on the change in the capacitance and determining bio-information of the object in contact from the detected light.

According to another aspect of the present invention, there is provided a method of operating a fingerprint sensor, including: detecting light emitted from a light source; detecting a change in capacitance generated from a plurality of electrodes by an object coming into contact with one surface of a substrate; and determining a fingerprint of the object in contact with the one surface of the substrate, based on the change in the capacitance and determining bio-information of the object in contact with the one surface of the substrate from the detected light.

In the determining, the bio-information of the object in contact with the one surface of the substrate may be determined from a quantity of the detected light.

In the determining, the bio-information of the object in contact may be determined by using a difference between a refractive index of the substrate providing a proceeding path of the light emitted from the light source and that of the object in contact.

In the determining, the bio-information of the object in contact with the one surface of the substrate may be determined with reference to a data table storing information regarding a quantity of light detected by a light detection unit according to a component of the object in contact with the one surface of the substrate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an outer appearance of a mobile device having a fingerprint sensor according to an embodiment of the present invention;

FIG. 2 is a schematic block diagram of a fingerprint sensor according to an embodiment of the present invention;

FIGS. 3A and 3B are perspective views of a fingerprint sensor according to an embodiment of the present invention;

FIG. 4 is a cross-sectional view taken along line A-A′ of the fingerprint sensor illustrated in FIG. 3A;

FIG. 5 is a cross-sectional view taken along line B-B′ of the fingerprint sensor illustrated in FIG. 3B;

FIG. 6 is a flow chart illustrating a process of a method of operating a fingerprint sensor according to an embodiment of the present invention; and

FIG. 7 is a view explaining a method of operating a fingerprint sensor according to an embodiment of the present invention.

### DETAILED DESCRIPTION OF THE INVENTION

Embodiments of the present invention will be described in detail with reference to the accompanying drawings. These embodiments will be described in detail for those skilled in the art in order to practice the present invention. It should be appreciated that various embodiments of the present invention are different, but do not have to be exclusive. For example, specific shapes, configurations, and characteristics described in an embodiment of the present invention may be implemented in another embodiment without departing from the spirit and the scope of the present invention. In addition, it should be understood that position and arrangement of individual components in each disclosed embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

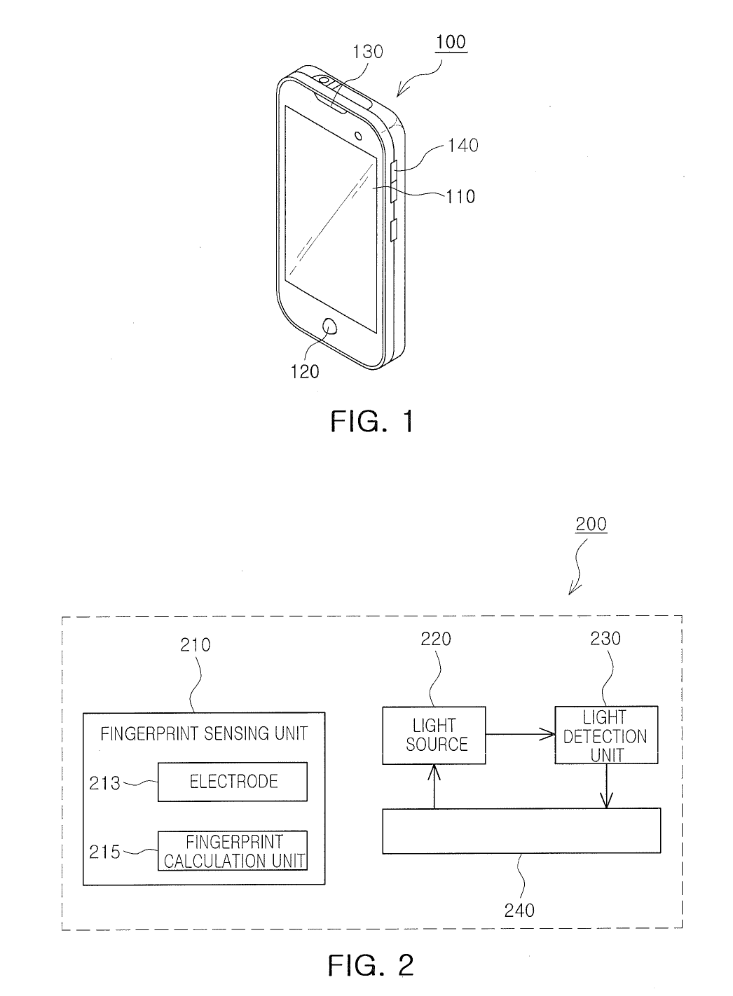

FIG. 1 is a view showing a mobile device to which a fingerprint sensor according to an embodiment of the present invention is applicable. With reference to FIG. 1, a mobile device 100 according to an embodiment of the present invention may include a display device 110 outputting a screen image, a fingerprint sensor 120, an audio unit 130 outputting a voice, an input unit 140, and the like. It is illustrated that the fingerprint sensor 120 is disposed at a lower portion of the display device 110, but the present invention is not necessarily limited thereto.

The mobile device 100 includes various circuits and function parts within a limited form factor in comparison to other home appliances, so it is very important to implement a particular function by hardware having relatively small size. Thus, the fingerprint sensor 120 may be implemented in a contact type fingerprint sensor such as a fingerprint sensor applied to a doorlock, or the like, or may be implemented in a swipe type fingerprint sensor having a relatively small width. In particular, when the fingerprint sensor is implemented as a swipe type fingerprint sensor, it may be provided as an integral type fingerprint sensor in the input unit 140 provided on the side of the mobile device 100.

The fingerprint sensor 120 described in an embodiment of the present invention may include a bio-information determining unit determining whether an object in contact is a living body, in addition to a fingerprint sensing unit for recognizing a fingerprint. The fingerprint sensing unit may be implemented according to various schemes such as a capacitance scheme, a light detection scheme, an ultrasonic wave scheme, or the like. Hereinafter, throughout the specification, fingerprint sensors according to various embodiments of the present invention are described through a capacitance type fingerprint sensing unit assumed for the sake of explanation, but it would be appreciated that an operation method of the fingerprint sensing unit of the fingerprint sensor is not necessarily limited to the capacitance scheme.

FIG. 2 is a schematic block diagram of a fingerprint sensor according to an embodiment of the present invention.

With reference to FIG. 2, a fingerprint sensor 200 may include a fingerprint sensing unit 210, a light source 220, a light detection unit 230, and a bio-information calculation unit 240. In FIG. 2, it is illustrated that an electrode 213 and a fingerprint calculation unit 215 are included in the fingerprint sensing unit 210, but the fingerprint calculation unit 215 may be implemented as a single integrated circuit (IC) along with the bio-information calculation unit 240 or may be included as a single circuit block in a main controller of the mobile device 100.

The fingerprint sensing unit 210 may include a plurality of electrodes 213, and capacitance in the plurality of electrodes 213 may be changed due to an object which is in proximity to or comes into contact with the fingerprint sensor 200. The change in the capacitance generated by each of the plurality of electrodes 213 may have a different value due to valleys and ridges present in a fingerprint, and the fingerprint calculation unit 215 may analyze a pattern of the fingerprint by using the change in the capacitance to generate fingerprint information. The fingerprint information generated by the fingerprint calculation unit 215 may be directly processed by the fingerprint calculation unit 215 and used to determine whether the user is a user registered to the mobile device 100 or may be transmitted to a main controller of the mobile device 100 so as to be used for user authentication.

The light source 220 may include at least one light emitting diode (LED) and emit light of a wavelength such as an infrared ray. Light emitted by the light source 220 may be reflected from within a dielectric substrate physically connected to the light source 220 so as to be incident to the light detection unit 230. The light detection unit 230 may detect a quantity of light which has reached without being lost after having been emitted from the light source 220, and the bio-information calculation unit 240 may determine whether the object in contact or in proximity is a living body including a real fingerprint or a forged fingerprint, based on the quantity of light detected by the light detection unit 230.

In order for the bio-information calculation unit 240 to accurately calculate bio-information based on the light detected by the light detection unit 230, it may be important to accurately know about the intensity of light emitted from the light source 220. Thus, parameters such as intensity, wavelength, and the like, of light emitted from the light source 220 may be controlled by the bio-information calculation unit 240. The bio-information calculation unit 240 may calculate how much of light having particular intensity emitted from the light source 220 has reached the light detection unit 230 and detected, to determine whether or not the object in proximity to or in contact with the fingerprint sensor 200 is a living body.

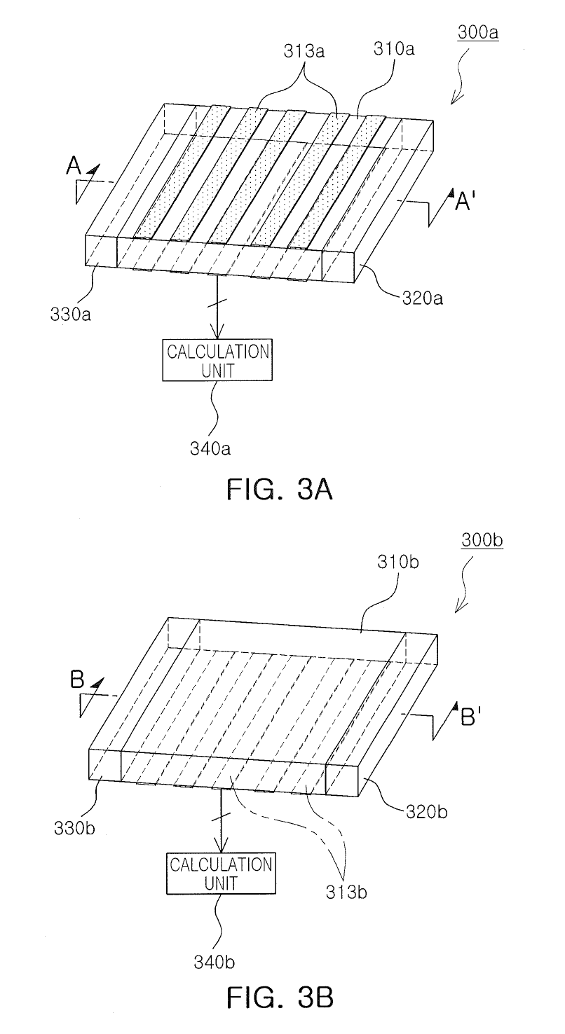

FIGS. 3A and 3B are perspective views of a fingerprint sensor according to an embodiment of the present invention.

With reference to FIG. 3A, the fingerprint sensor 300a may include a substrate 310a, a plurality of electrodes 313a provided on one surface of the substrate 310a, a light source 320a and a light detection unit 330a provided at both ends of the substrate 310 in a particular direction, respectively, and a calculation unit 340a. Unlike the case illustrated in FIG. 2, in FIGS. 3A and 3B, it is assumed that the fingerprint calculation unit 215 and the bio-information calculation unit 240 are implemented in a single calculation unit 340a.

The electrodes 313a may be disposed on an upper surface of the substrate 310a, namely, on a fingerprint recognition surface to or with which a particular object is in proximity or comes into contact. Also, according to a method of recognizing a fingerprint, the electrodes 313a may be further provided on a lower surface, opposite to the upper surface of the substrate 310a. The calculation unit 340a may be electrically connected to the respective electrodes 313a, and may supply electric charges to the respective electrodes 313a to charge or discharge the charges, that is, by a capacitance scheme, so as to be able to recognize valleys and ridges of the fingerprint.

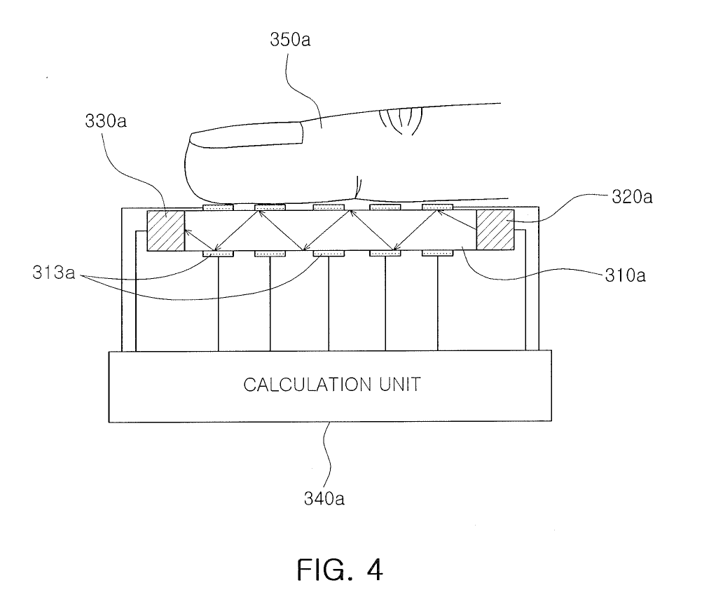

The substrate 310a may have a permittivity and accommodate proximity or contact of an object through at least one surface thereof. The light source 320a and the light detection unit 330a may be disposed in a facing manner at both ends of one surface of the substrate 310a to or with which the object is in proximity or comes into contact, and light emitted from the light source 320a may be reflected within the substrate 310a and become incident to the light detection unit 330a. In order to use a total reflection principle such as being applied to optical communications, permittivity of the interior of the substrate 310a may be greater than that of the exterior of the substrate 310a. This will be described with reference to FIG. 4.

FIG. 4 is a cross-sectional view taken along line A-A′ of the fingerprint sensor illustrated in FIG. 3A. With reference to FIG. 4, the light source 320a and the light detection unit 330a may be respectively disposed at both ends of the substrate 310a, and light emitted from the light source 320a may be reflected from inner and outer interfaces of the substrate 310a to proceed to the light detection unit 330a. The plurality of electrodes 313a provided on upper and lower surfaces of the substrate 310a, as well as the light source 320a and the light detection unit 330a, are connected to the calculation unit 340a.

When the calculation unit 340a controls the light source 320a to emit light having a wavelength and intensity, light emitted from the light source 320a may be reflected from the inner and outer interfaces of the substrate 310a and become incident to the light detection unit 330a. When a refractive index within the substrate 310a is greater than that of the outside, e.g., air, of the substrate 310a, total reflection may be formed, such that the entire light emitted from the light source 320a becomes incident to the light detection unit 330a. However, as shown in FIG. 4, the refractive index of an object in contact 350a at a portion where the object in contact 350a exists may be greater than that of the interior of the substrate 310a, and in this case, light may be transmitted through the interfaces of the substrate 310a at a portion of the interfaces. In this case, light reflected with regard to the intensity after being lost may be detected by the light detection unit 330a, and the calculation unit 340a may be able to determine whether the object in contact 350a is a living body.

With reference to FIG. 3B, the fingerprint recognition sensor 300b may include a substrate 310b, a plurality of electrodes 313b provided on one surface of the substrate 310b, a light source 320b and a light detection unit 330b respectively provided at both ends of the substrate 310b in a particular direction, and a calculation unit 340b. Unlike the case of FIG. 3A, in FIG. 3B, the electrodes 313b may be provided on a lower surface of the substrate 310b. A change in capacitance for detecting a fingerprint according to contact or proximity may be affected according to permittivity of the substrate 310b.

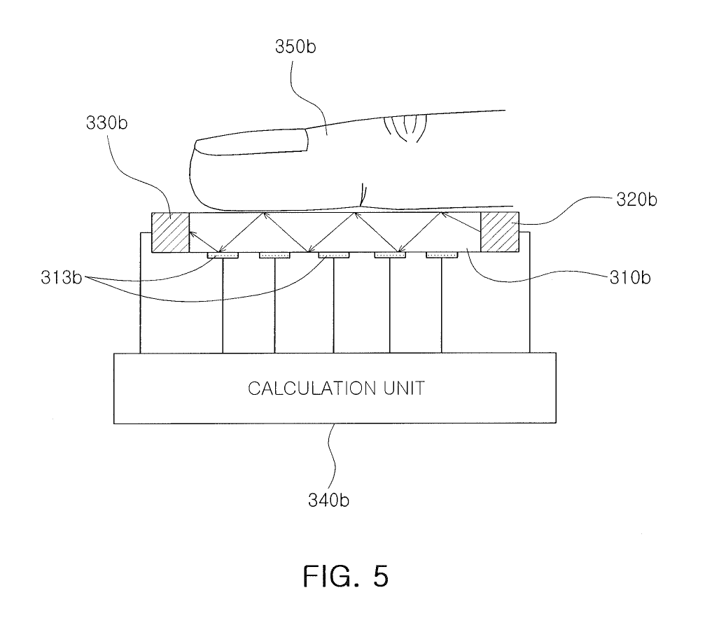

FIG. 5 is a cross-sectional view taken along line B-B′ of the fingerprint sensor illustrated in FIG. 3B. With reference to FIG. 5, the light source unit 320b and the light detection unit 330b may be disposed at both ends of the substrate 310b, and the electrodes 313b may be disposed on the lower surface of the substrate 310b. As described above with reference to FIG. 4, light emitted from the light source 320b becomes incident to the light detection unit 330b along the interior of the substrate 310b, and the calculation unit 340b may determine whether or not the object in contact 350b is a living body by using the intensity of light, i.e., the quantity of light, or the like, detected by the calculation unit 340b.

In order to accurately determine whether the object 350a, 350b that comes into contact with the substrate 310a, 310b is a living body, light emitted from the light source 320a, 320b may entirely reaches the light detection unit 330a, 330b when the object in contact 350a, 350b is not present. Also, when the object in contact 350a, 350b is a living body, a quantity of light may be transmitted through the interface between the substrate 310a, 310b and the object in contact 350a, 350b so as to be leaked out, such that it is accurately determined whether the object 350a, 350b coming into contact with the substrate 310a, 310b is a living body. Thus, the permittivity of the substrate 310a, 310b may be greater than that of air and smaller than that of the living body or the skin.

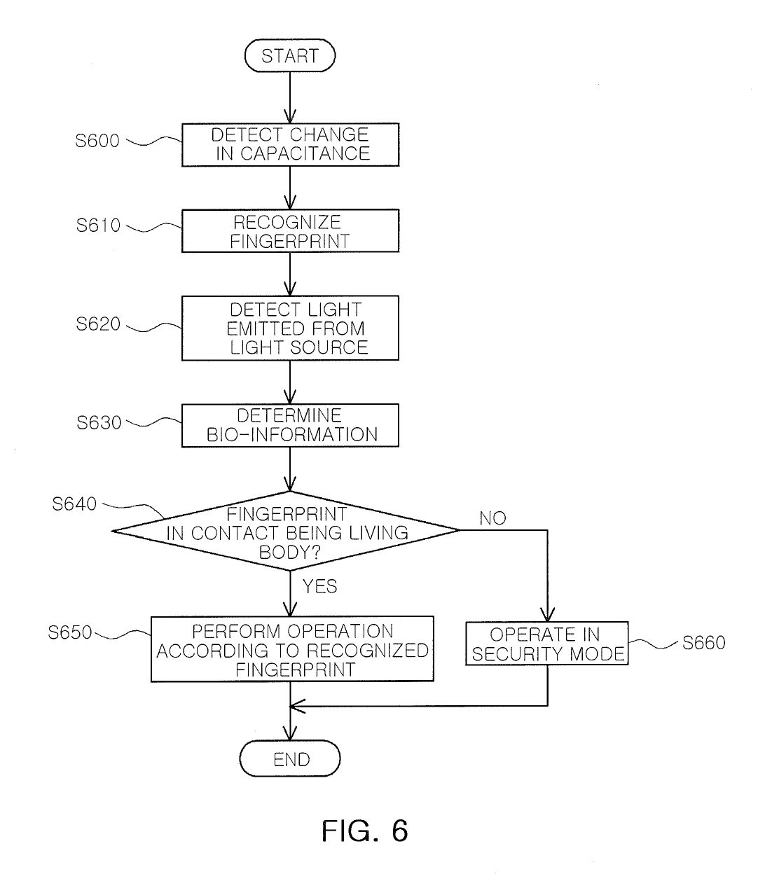

In a case in which the permittivity of the substrate 310a, 310b is greater than that of air and smaller than that of the living body or the skin, when the living body does not come into contact, the intensity of light emitted from the light source 320a, 320b and the intensity of light detected by the light detection unit 330a, 330b may appear to be almost equal. Meanwhile, when the living body comes into contact, light passing through the interface between the substrate 310, 310b and the living body may be generated, so the intensity of light detected by the light detection unit 330a, 330b may appear to be smaller than that of light emitted from the light source 320a, 320b. Here, in order to prevent an error of determination, the fingerprint sensor may first determine whether or not a fingerprint comes into contact, based on a change in capacitance generated from the electrodes 313a, 313b, and then, determine whether or not the object in contact is a living body. This will be described with reference to FIG. 6 as follows.

FIG. 6 is a flow chart illustrating a process of a method of operating a fingerprint sensor according to an embodiment of the present invention.

With reference to FIG. 6, the method of operating the fingerprint sensor 200 according to the present embodiment may start to detect, by the fingerprint sensing unit 215, a change in capacitance generated from the electrodes 213 (S600). As described above, the fingerprint sensing unit 215 may recognize valleys and ridges of a fingerprint based on the change in the capacitance detected in operation S600, and analyze a pattern of the fingerprint based on the recognized valleys and ridges of the fingerprint to determine whether or not the fingerprint currently in contact is a fingerprint of a registered user or a fingerprint of a non-registered user (S610).

When the finger recognition is completed, the bio-information calculation unit 240 may detect light from the light detection unit 230, the light having been emitted from the light source 220 (S620). The intensity, wavelength, and the like, of light emitted from the light source 220 may be controlled by the bio-information calculation unit 240, and the bio-information calculation unit 240 may compare the intensity of light received from the light detection unit 230 with light initially emitted from the light source 220. According to the comparison results, the bio-information calculation unit 240 may be able to determine whether or not the currently object in contact corresponds to a living body of a human being (S630).

When determination of bio-information is completed, the bio-information calculation unit 240 may determine a follow-up operation according to whether or not the fingerprint in contact is a living body (S640). When the object which has come into contact and generated the fingerprint information is determined to be a living body, the bio-information calculation unit 240 provides control to perform an operation according to the recognized fingerprint (S650). For example, in the case of the fingerprint sensor 200 installed within the mobile device 100, when the fingerprint is a fingerprint of a registered user and it is recognized as a living body, the bio-information calculation unit 240 may provide control to turn power of the mobile device 100 on or change the mobile device 100 in a sleep mode to an active mode thereof.

Meanwhile, according to the determination results in operation S640, when the object which has come into contact and generated the fingerprint information is determined to be an object, i.e., a forged fingerprint formed using silicon, or the like, rather than a living body, the bio-information calculation unit 240 may control the mobile device 100 to operate in a security mode (S660). Namely, the bio-information calculation unit 240 may turn power of the mobile device 100 off or control the mobile device 100 to perform an operation such as maintaining, or the like, the sleep mode until a fingerprint authentication is successful.

In FIG. 6, it is illustrated that the fingerprint recognizing operation (S600, S610) is first executed, and then, the bio-information determination operation (S620 to S660) is later executed, but the present invention may be implemented by any other embodiments. Namely, before the fingerprint recognition operation is executed, bio-information may be first determined. When bio-information is first determined, whether to execute a fingerprint recognizing operation may be determined according to the bio-information determination results, i.e., according to whether or not an object in contact is a living body. Thus, when the object in contact is not a living body, the mobile device 100 may be immediately controlled to operate in the security mode without executing the fingerprint recognizing operation, thereby implementing an operation algorithm more simply.

Meanwhile, as shown in FIG. 6, when the fingerprint recognizing operation is first executed, bio-information may be determined only when an object including a fingerprint comes into contact by executing fingerprint recognizing operation. Thus, when an object without a fingerprint comes into contact, the bio-information determination operation may be omitted. Thus, the both cases are embodiments that may achieve the intended effects of the present invention and should be construed to be within the scope of the present invention.

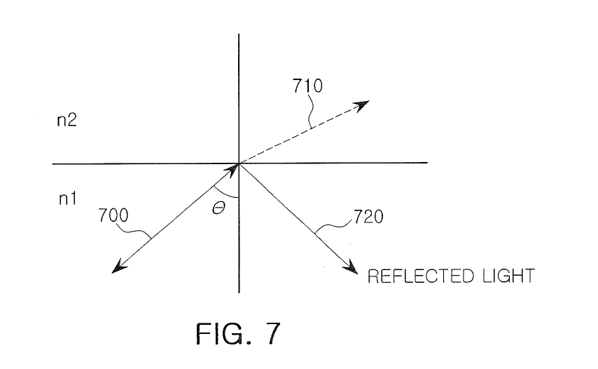

FIG. 7 is a view explaining the method of operating a fingerprint sensor according to an embodiment of the present invention.

With reference to FIG. 7, directions in which light is proceeding between objects having different refractive indexes n1 and n2, respectively, are illustrated. Hereinafter, for the sake of explanation, it is assumed that the refractive index of the substrate included in the fingerprint sensor of the present invention is n1 and that of air or an object in contact is n2.

As described above, when there is no object in contact, the refractive index n1 of the substrate is greater than the refractive index n2 of air, i.e., a value 1.0006, so light (700) proceeding within the substrate cannot pass through the interface of the substrate and air and may be entirely reflected to the interior of the substrate to proceed (720). Thus, the intensity of light emitted from the light source and that of light detected by the light detection unit may be almost equal, and in this case, the bio-information determining unit may recognize that there is no object in contact or a forged fingerprint is in contact.

Meanwhile, when there is present an object in contact, a proceeding path of light varies according to the size relationship between the refractive index n1 of the substrate and the refractive index n2 of the object in contact. In case of n1>n2, like the case in which there is no object in contact, light (700) proceeding within the substrate cannot pass through the interface of the substrate and air and may be mostly reflected to the interior of the substrate (720). However, in case of n1<n2, light (710) which penetrates from the interface of the substrate to the outside may be generated according to the refractive index of the object in contact, and accordingly, the intensity of light (720) reflected to the interior of the substrate may be reduced by the intensity of passed light (710).

When the refractive index of a human skin or body is stored in the form of a data table in a memory in advance, bio-information may be determined based on the properties illustrated in FIG. 7. For example, on the assumption that the intensity of light emitted from the light source is 100, and that the intensity of light detected by the light detection unit when a body comes into contact according to the range of the refractive index of the body ranges from 65 to 75, when the intensity of light detected by the light detection unit is a value smaller than 65 or a value between 75 and 100, it may be determined that the object is a forged fingerprint or an object that does not have a fingerprint. Thus, a glass substrate, or the like, having relatively high permittivity may be used to accurately determine bio-information in consideration of the value of the refractive index the body may have.

As set forth above, according to embodiments of the invention, a fingerprint of an object in contact is recognized from an electrical signal which is differently generated from valleys and ridges of the fingerprint, and at the same time, whether or not the contact object is a living body or an object used for a forged fingerprint fabricated with silicon, or the like, is determined based on the quantity of light detected by the light detection unit. Also, by disposing the light source and the light detection unit at both ends of the sensor substrate for recognizing a fingerprint, a fingerprint sensor having a bio-information discrimination function capable of significantly reducing a request for an additional space may be provided.

While the present invention has been shown and described in connection with the embodiments, it will be apparent to those skilled in the art that modifications and variations can be made without departing from the spirit and scope of the invention as defined by the appended claims.

What is claimed is:

1. A fingerprint sensor comprising:
a fingerprint sensing unit sensing a fingerprint coming into contact with one surface of a substrate;
a light source provided at a first end of the substrate; and
a light detection unit provided at a second end of the substrate and detecting light emitted from the light source,
the first and second ends respectively corresponding to both ends of the one surface of the substrate contacting the fingerprint, and bio-information of an object coming in contact with the one surface of the substrate being determined by using light detected by the light detection unit.

2. The fingerprint sensor of claim 1, wherein the fingerprint sensing unit includes:
a plurality of electrodes having electrical conductivity; and
a fingerprint calculation unit detecting the fingerprint by using a change in capacitance generated in the plurality of electrodes by the object in contact with the one surface of the substrate.

3. The fingerprint sensor of claim 1, further comprising a bio-information calculation unit determining bio-information of the object in contact with the one surface of the substrate by using light detected by the light detection unit.

4. The fingerprint sensor of claim 3, wherein the bio-information calculation unit determines the bio-information by using a difference between a refractive index of the interior of the substrate and that of the object in contact with the one surface of the substrate.

5. The fingerprint sensor of claim 4, wherein the bio-information calculation unit determines the bio-information of the object in contact with the one surface of the substrate with reference to a data table storing information regarding a quantity of light detected by the light detection unit according to a component of the object in contact with the one surface of the substrate.

6. The fingerprint sensor of claim 1, wherein the light source includes at least one light emitting diode (LED).

7. A method of operating a fingerprint sensor, the method comprising:
detecting a change in capacitance generated from a plurality of electrodes by an object coming into contact with a substrate;
detecting light emitted from a light source; and
determining a fingerprint of the object in contact with the substrate, based on the change in the capacitance and determining bio-information of the object in contact from the detected light.

8. A method of operating a fingerprint sensor, the method comprising:
detecting light emitted from a light source;
detecting a change in capacitance generated from a plurality of electrodes by an object coming into contact with one surface of a substrate; and
determining a fingerprint of the object in contact with the one surface of the substrate, based on the change in the capacitance and determining bio-information of the object in contact with the one surface of the substrate from the detected light.

9. The method of claim 7, wherein, in the determining, the bio-information of the object in contact with the one surface of the substrate is determined from a quantity of the detected light.

10. The method of claim 7, wherein, in the determining, the bio-information of the object in contact is determined by using a difference between a refractive index of the substrate providing a proceeding path of the light emitted from the light source and that of the object in contact.

11. The method of claim 7, wherein, in the determining, the bio-information of the object in contact with the one surface of the substrate is determined with reference to a data table storing information regarding a quantity of light detected by a light detection unit according to a component of the object in contact with the one surface of the substrate.

12. The method of claim 8, wherein, in the determining, the bio-information of the object in contact with the one surface of the substrate is determined from a quantity of the detected light.

13. The method of claim 8, wherein, in the determining, the bio-information of the object in contact is determined by using a difference between a refractive index of the substrate providing a proceeding path of the light emitted from the light source and that of the object in contact.

14. The method of claim 8, wherein, in the determining, the bio-information of the object in contact with the one surface of the substrate is determined with reference to a data table storing information regarding a quantity of light detected by a light detection unit according to a component of the object in contact with the one surface of the substrate.
